(19) United States
(12) Patent Application Publication
(10) Pub. No.: US 2023/0088948 A1
(43) Pub. Date: Mar. 23, 2023

(54) Shaman's Germinator

(71) Applicant: Charles William Pace, III, Eugene, OR (US)

(72) Inventor: Charles William Pace, III, Eugene, OR (US)

(21) Appl. No.: 17/479,588

(22) Filed: Sep. 20, 2021

(51) Int. Cl. A01G 9/029; A01G 24/20

(52) U.S. Cl. CPC A01G 9/0293; A01G 24/20

(57) ABSTRACT

The most productive way to germinate a plant seed is to simulate the seeds natural germination environment, any and all germination devices attempt to do this in their own way yet all previous inventions have their own down falls. Shaman's Germinator solves all these problems in a simple and easy to use device while allowing the user to safely monitor the germination process and can be used with any growing medium.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND

The present invention relates to the field of botany, specifically the germination of plant seeds.

The most productive way to germinate a plant seed is to simulate the seeds natural germination environment, any and all germination devices attempt to do this in their own way, yet all previous inventions have their own down falls. Shaman's Germinator solves all these problems in a simple and easy to use device while allowing the user to safely monitor the germination process and use with any growing medium.

The most common germination devices consist of a small container that the user fills with soil or coco substrate which the seed is planted into. Typically there are many of these small containers connected together with a clear humidity dome above. These devices simulate a natural environment fairly well but the user cannot monitor the germination process because the seed is buried within the medium. Because the user cannot see the seed the entire process becomes a guessing game leading to under watering or over watering which can lead to seed rot or seedling rot after germination or drowning and suffocation. Furthermore, most of these devices don't allow the user many options for a growing medium. For instance, a hydroponics grower wouldn't want to start their seed in soil or coco and thus would not want to use any of these types of seed starter trays.

Many home gardeners use an archaic method which utilizes a bowl with a wet paper towel, commonly known as “the paper towel method”. This allows the germination process to be viewed as well as allows the seed to be placed inside any growing medium after germination but this method commonly leads to pour results in that very often the new seedlings will dry out and die if the process is not constantly monitored and maintained several times throughout the day and night. In the same respect, it is very easy to over water and drown the seeds using this process. This process also exposes the new seedling root to harmful levels of light that is not part of a natural germination environment.

Other more elaborate devices try solving some of these later problems by using a clear germination chamber that keeps humidity in and allows the viewer to observe the entire process and maintain the moisture content. Most commonly these devices are extravagant designs contrived for laboratory use making them bulky, expensive and not available to home gardeners. These designs also all use a clear germination chamber that allows harmful amounts of light to reach the seedling which can hinder the germination process as well as lead to root fungus.

### BRIEF SUMMARY OF THE PRESENT INVENTION

The present invention seeks to provide a simple solution to the previously mentioned problems that the previously patented germination devices have by utilizing a translucent, colored glass (or plastic) chamber with air vents, water ports, photon windows and a condensation cap.

### BRIEF DESCRIPTION OF DRAWINGS

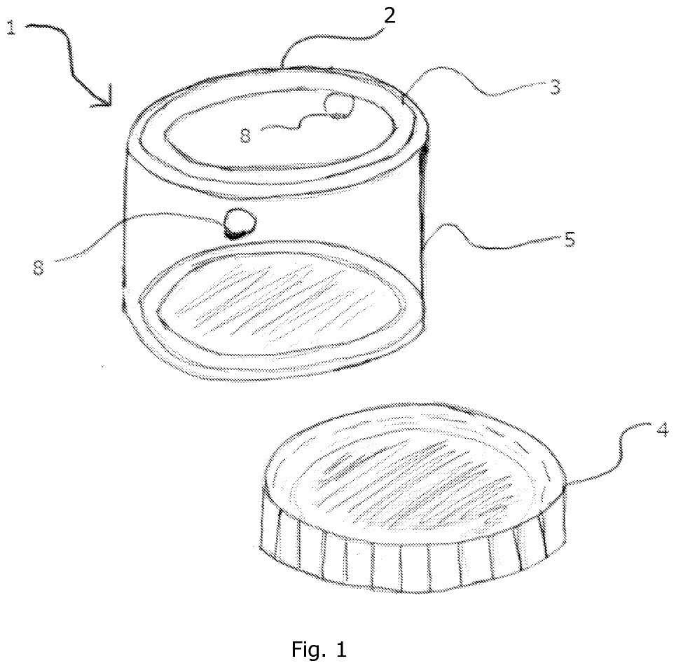

FIG. 1:
1. Shaman's Germinator.
2. Wide-mouth opening.
3. Molded Rim: Molded with basic notches, threads or any such way to accept a matching cap.
4. Condensation Cap: Airtight cap keeps the condensation inside the device.
5. Germination Chamber: Chamber made of translucent, colored or tinted glass (or plastic). Blocks harmful light while still allowing user to visually monitor the germination progress.
8. Air Portal/Photon Portal/Water Portal: Portals allow fresh air to enter the device without allowing the majority of condensation out as well as allowing only a small amount of full spectrum light to reach the seedling. In addition to photon and air portals, they also act as watering portals.

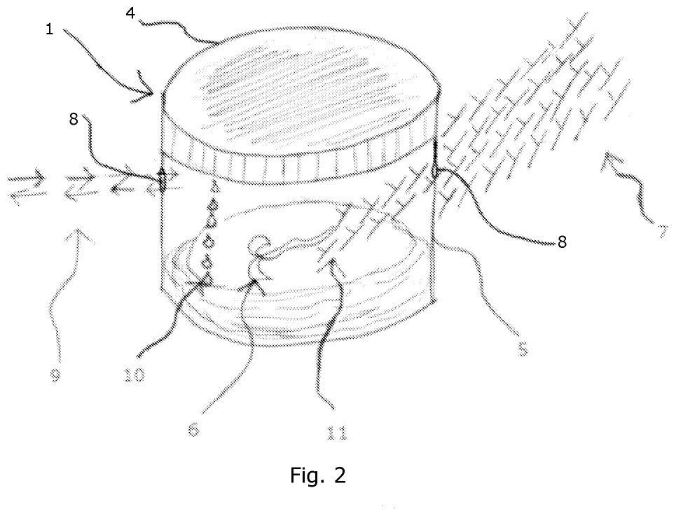

FIG. 2:
1. Shaman's Germinator.
4. Condensation Cap: Airtight cap keeps the condensation inside the device.
5. Germination Chamber: Chamber made of translucent, colored or tinted glass (or plastic). Blocks harmful light while still allowing user to visually monitor the germination progress.
6. Germinating seedling, resting atop some wet wick able medium, viewable to the user.
7. Harmful amounts of red light, orange light, yellow light, blue light, indigo light, violet and UV light being blocked.
8. Air Vents/Photon Portal/Water Portal: Portals allow fresh air to enter the device without allowing the majority of condensation out as well as allowing only a small amount of full spectrum light to reach the seedling. In addition to photon and air portals, they also act as watering portals.
9. Fresh and used air circulating in and out of the device chamber.
10. Condensation trapped inside the device, recycling down the chamber wall to the wick able medium.
11. A small amount of full spectrum light allowed into the device through the photon ports to help entice and feed the seedling.

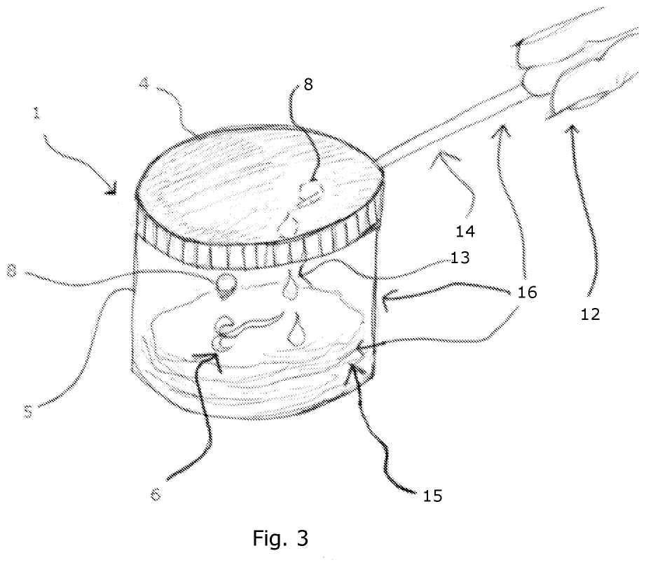

FIG. 3:
1. Shaman's Germinator.
4. Condensation Cap: Airtight cap keeps the condensation inside the device.
5. Germination Chamber: Chamber made of translucent, colored or tinted glass (or plastic). Blocks harmful light while still allowing user to visually monitor the germination progress.
6. Germinating seedling, resting atop some wet wick able medium, viewable to the user.
8. Air Portal/Photon Portal/Water Portal: Portals allow fresh air to enter the device without allowing the majority of condensation out as well as allowing only a small amount of full spectrum light to reach the seedling. In addition to photon and air portals, they also act as watering portals.
12. The user's fingertips.
13. Extra water/nutrients being dripped into the system.
14. Water Dropper—dripping water into the device, by the user.
15. Wick able medium or substrate such as organic cotton, soil, coco coir, Rockwool or paper towel.
16. Shamans Germinator-Kit: The Germinator-Kit includes at least one germination device, at least one glass or plastic water dropper and enough wick able medium to attempt at least one germination cycle per device.

### DETAILED DESCRIPTION OF THE PRESENT INVENTION

Shaman's Germinator[1] is a professional and/or household germination device, process and main component of a kit used for the germination of heirloom seeds or any other important type of seed the average person might want to germinate. The device is a short, wide-mouth[2], translucent, colored glass (or plastic), round cup like chamber with straight walls, molded on the rim[3] to accept a condensation cap[4]. The device can be scaled in size and shape depending on the application. The chamber of Shaman's Germinator is made of a translucent, colored (or tinted) glass[5] (or plastic) such as, but not limited to, green or amber, which allows the user to view the seedling[6] during germination but will block some of the harmful; red light, orange light, yellow light, blue light, indigo light, violet and UV light[7] (respectively to the color of the chamber) from reaching the seedling. The device has at least two portals[8] on the sidewalls, just below the lid molding, each located on parallel sides of the chamber to one another. These air portals play a critical role in the function of the device by allowing fresh-air[9] to enter the device without allowing the majority of condensation[10] out, as well as allowing a small and true light source[11] to reach the seedling, simulating a natural germination environment that can always be visibly monitored. The portals are also used as water ports, allowing the user[12] to drip extra water/nutrients[13] into the system with a water dropper[14] without opening the device and letting the condensation out, or letting much light in. These portals are either built into the mold for hot casting/injection molding, or they can be drilled or cut out of the side of the chamber after molding the glass (or plastic) germination chamber.

To use the present invention: After sanitizing the chamber and cap; a layer of a wick able medium[15] such as organic cotton, soil, coco coir, paper towel or Rockwool is placed in the bottom of the chamber, not to exceed a height that is half way to the height of the air vents, then nutrient filled or plain distilled water is added. The seed is placed on top of the wet medium so that half of the seed is submerged in water while the opposite half of the seed is exposed to air. The device is then closed with the condensation cap which will allow the condensation to drip back down the side walls and block the light from above. The device can be placed on a heat mat to keep a desired temperature for germination or simply placed in an area with the correct temperature such as under a seedling light. Under average conditions the device requires low maintenance by adding water once or twice a day through the water port, with a dropper, to keep the level of water near the midsection of the seed after the device starts creating condensation within. If used correctly the seed will not dry out and will not drown. After the user sees that the seed has germinated with a well-established root the user can simply open the condensation cap, hold the device upside-down above the desired planting container and the seedling will drop in place without having to touch it. Or, the user can easily scoop the seedling out with a sanitized spoon because the chamber is short and has a wide opening. Although the device is designed to concentrate and amplify the germination process for one seed, multiple seeds can be germinated in one device at the same time.

Shaman's Germinator is an improvement from the previous patented germination devices [(U.S. Pat. No. 1,635,498), (U.S. Pat. No. 1,648,309), (U.S. Pat. No. 2,256,414), (U.S. Pat. No. 3,911,619), (U.S. Pat. No. 4,000,580), (U.S. Pat. No. 4,369,598), (U.S. Pat. No. 5,094,033), (U.S. Pat. No. 5,651,214), (U.S. Pat. No. 5,806,242), (U.S. Pat. No. 11,019,764B2), (D291,979)] for the following reasons:

Using a small wide mouth translucent chamber with a lid is an improvement over devices utilizing small open soil pots [(U.S. Pat. No. 1,635,498), (U.S. Pat. No. 2,256,414), (U.S. Pat. No. 5,094,033)], being that the user can see the seed as it germinates. A chamber allows the user to better maintain a perfect air to water ratio. A chamber holds the temperature better. A sealed chamber holds condensation better. Using a chamber allows the seedling to breathe better than when buried in dirt. Germinating inside a translucent chamber also allows the user to choose their preferable medium to germinate and then transfer the seedling into.

Using a short and wide mouth chamber with lid makes it easy to insert and remove a seed whereas the other chamber devices [(U.S. Pat. No. 4,369,598), (U.S. Pat. No. 4,000,580), (U.S. Pat. No. 3,911,619), (U.S. Pat. No. 1,648,309), (U.S. Pat. No. 5,806,242), (D 291,979)] all focus the design of the chamber based on fancy ways to collect condensation rather than making the device user friendly.

The use of a translucent colored glass (or plastic) chamber better simulates a natural germination environment than the previous patented germination devices with clear see-through chambers [(U.S. Pat. No. 1,635,498), (U.S. Pat. No. 2,256,414), (U.S. Pat. No. 4,000,580), (U.S. Pat. No. 5,094,033), (U.S. Pat. No. 5,651,214), (U.S. Pat. No. 5,806,242)] by blocking some of the harmful red light, orange light, yellow light, blue light, indigo light, violet light and ultra violet light from entering the germination chamber while still allowing the user to view and monitor the process without disturbing the germination environment in any way.

Shaman's Germinator allows a specific controlled environment for germinating one to a few important seeds at a time within each chamber, this allows a better focused and controlled environment for each seed while still allowing the capability to place multiple devices next to each other within a small footprint to germinate many seeds. Shaman's Germination chambers can even be stacked on one another to save space, which none of the other devices can do.

This germination device is called Shaman's Germinator[1]. Shaman's Germinator-Kit[16] includes at least one germination device, at least one glass or plastic water dropper and enough wick able medium to perform at least one germination cycle per device.

1. I claim this device called Shaman's Germinator which is used to germinate plant seeds and is made with a wide mouth, translucent, colored glass (or plastic) chamber that has air vents, water ports, photon windows and a condensation cap.

2. I claim the use of a translucent and colored glass (or plastic) germination chamber, specifically green (or amber) colored, to block some of the red light, orange light, yellow light, blue light, indigo light, violet light and ultra violet light from entering the germination device, which simulates a true germination environment while allowing the process to be visibly monitored by the user.

3. I claim the packaging of a germination device (as mentioned above) along with a water dropper and enough wick able medium (such as organic cotton) to attempt one germination cycle as a Germination-Kit, which will be called Shaman's Germination-Kit.
